(19) United States
(12) Patent Application Publication
(10) Pub. No.: US 2026/0031366 A1
(43) Pub. Date: Jan. 29, 2026

(54) PROCESS AND MEMBRANE

(71) Applicant: JOHNSON MATTHEY HYDROGEN TECHNOLOGIES LIMITED, LONDON (GB)

(72) Inventors: William BANGAY, Reading, Berkshire (GB); Cecilia BERNARDINI, Reading, Berkshire (GB); James STEVENS, Reading, Berkshire (GB); Chris ZALITIS, Reading, Berkshire (GB)

(21) Appl. No.: 19/099,373

(22) PCT Filed: Sep. 28, 2023
(86) PCT No.: PCT/GB2023/052510

§ 371 Date: Jan. 28, 2025

(30) Foreign Application Priority Data
Sep. 29, 2022 (GB) 2214254.1

(51) Int. Cl. H01M 4/88; C25B 13/08; H01M 4/86; H01M 4/92; H01M 8/1027; H01M 8/1032; H01M 8/1039; H01M 8/1053; H01M 8/1067; H01M 8/1069

(52) U.S. Cl. CPC H01M 4/881; C25B 13/08; H01M 4/8663; H01M 4/928; H01M 8/1027; H01M 8/1032; H01M 8/1039; H01M 8/1053; H01M 8/1067; H01M 8/1069

(57) ABSTRACT

A process for producing an ion-conducting membrane comprising a recombination catalyst-containing membrane layer. The membrane layer if fabricated from an ink comprising a stabilised dispersion of recombination catalyst nanoparticles. Also provided are ion-conducting membranes for electrochemical devices, such as fuel cells or water electrolysers, with a recombination catalyst-containing membrane layer comprising dispersed recombination catalyst nanoparticles, a nanoparticle stabilising agent, and an ion-conducting polymer.

### FIELD OF THE INVENTION

The present invention relates to ion-conducting membranes that are suitable for use in electrochemical devices, such as water electrolysers and fuel cells, to catalyst-coated membranes incorporating such ion-conducting membranes, and to processes for their production.

### BACKGROUND

The electrolysis of water to produce high purity hydrogen and oxygen can be carried out in both alkaline and acidic systems. Those electrolysers that employ a solid proton-conducting polymer electrolyte membrane, or proton exchange membrane (PEM), are known as proton exchange membrane water electrolysers (PEMWEs). Those electrolysers that utilise a solid anion-conducting polymer electrolyte membrane, or anion exchange membrane (AEM), are known as anion exchange membrane water electrolysers (AEMWEs).

Ion-conducting membranes, such as PEMs and AEMs, are also used in fuel cells. In a proton exchange membrane fuel cell (PEMFC), the membrane is proton conducting, and protons, produced at the anode, are transported across the membrane to the cathode, where they combine with oxygen to form water.

Catalyst-coated membranes (CCMs) may be employed within electrochemical devices, such as electrolysers and fuel cells. Such CCMs comprise an ion-conducting membrane, such as a PEM or AEM, with at least one of an anode catalyst layer and a cathode catalyst layer applied to a face of the membrane.

For water electrolyser applications, hydrogen evolution reaction (HER) catalysts are used in such cathode catalyst layers, for example HER catalysts comprising platinum, such as platinum on a carbon support. Oxygen evolution reaction (OER) catalysts are utilised in electrolyser anode catalyst layers. For PEMWE applications, suitable OER catalysts comprise iridium or iridium oxide (IrOx), or oxides containing both iridium and ruthenium. For AEMWE applications, non-platinum group metal OER catalysts may also be used, such as alloys and oxides of nickel, cobalt, iron, and copper.

For fuel cell applications, oxygen reduction reaction (ORR) catalysts are used in cathode catalyst layers and hydrogen oxidation reaction (HOR) catalysts are utilised in anode catalyst layers. For PEMFC applications, suitable cathode and anode catalyst materials comprise a platinum group metal (PGM) or an alloy of a PGM with one or more other metals, for example platinum or an alloy of platinum with one or more other metals.

Separate film layers, typically formed from non-ion conducting polymers, may be positioned around the edge region of a CCM, for example on exposed surfaces of the ion-conducting membrane where no electrocatalyst is present (but will also often overlap on to the edge of the electrocatalyst layer) to provide a seal to prevent escape of reactant and product gases, to reinforce and strengthen the edge of the CCM and provide a suitable surface for supporting subsequent components such as sub-gaskets or elastomeric gaskets. An adhesive layer may be present on one or both surfaces of the seal film layer.

CCMs may be incorporated into a membrane electrode assembly (MEA), which is essentially composed of five layers. The central layer is the polymer ion-conducting membrane. On either side of the ion-conducting membrane there is an electrocatalyst layer, containing an electrocatalyst designed for the specific electrolytic reaction. Finally, adjacent to each electrocatalyst layer there is a gas diffusion layer or a porous transport layer, depending on the final MEA application and stack configuration. Such layers allow the reactants to reach the electrocatalyst layer and products to leave.

It is desirable to reduce the thickness of such ion-conducting membranes to minimise electronic and ionic resistance. However, it is also important to minimise any hydrogen crossover through the membrane, to avoid hydrogen mixing with oxygen and associated safety concerns.

For water electrolysers, it is beneficial to maintain low levels of hydrogen crossover even at high pressure differentials across the membrane. The use of high pressures during electrolyser operation is advantageous as it reduces the requirement for compression of the generated hydrogen and reduces operating costs. This has led to the use of membranes with a thickness of over 125 μm, and typically close to 200 μm, or thicker. Examples of currently used membranes include Nafion™ N115 (thickness 125 μm) or Nafion™ N117 (thickness 175 μm).

It is known to produce proton exchange membranes comprising recombination catalysts which catalyse the reaction between hydrogen and oxygen to form water and therefore reduce levels of hydrogen crossover. For example, it is described in WO2020/148545 (Johnson Matthey Fuel Cells Ltd) that a catalyst comprising platinum on a graphene support may be introduced into a proton exchange membrane. In addition, CN114874475 (FOSHAN CLEANEST ENERGY TECH CO LTD) describes the use of platinum particles supported on hollow polydopamine microspheres in a proton exchange membrane. In such cases the platinum particles are localised within the membrane on the surface of the catalyst supports.

It is also known to incorporate platinum nanoparticles into ion-conducting membranes. For example, U.S. Pat. No. 10,476,094 (LG Chem Ltd) describes a reinforced membrane including a porous polymeric support. Platinum nanoparticles are provided on both surfaces of the porous polymer support and the surface in the pores. In order to prepare the membrane a porous support is immersed in a solution of a platinum precursor and the precursor subsequently reduced by adding a reducing agent. Such methodology has a number of manufacturing disadvantages. For example, immersion of the porous polymeric support in the platinum precursor solution can lead to swelling and/or deformation of the support during impregnation, and such immersion and drying methodology is hard to reproduce on a large manufacturing scale. Furthermore, the requirement to co-locate the reinforcement component and the platinum nanoparticles restricts the scope available for optimising performance through modifying membrane configuration and limits the ability to disperse the nanoparticles.

A similar approach involving the localised deposition of Pt nanoparticles onto the pores of a PTFE film is described in the paper ‘Reinforced and self-humidifying composite membrane for fuel cell applications’; Liu et al, Journal of Membrane Science, 330 (2009) 357-362. It is also described in US2015/0236354 (Solvicore GMBH & Co. KG) that colloidal dispersions comprising nano-sized precious metal particles and an ionomer component may be formed by dissolving a suitable precious metal precursor with a liquid acidic ionomer component followed by a reduction step. Such colloidal dispersions are free of other constituents.

The incorporation of recombination catalyst particles into ion-conducting membrane layers remains challenging. It is difficult to reproducibly produce consistent inks containing both ion-conducting polymers and catalyst particles which maintain their properties upon storage. Typically, this means that such inks have to be prepared shortly before manufacture therefore reducing manufacturing flexibility.

The inclusion of recombination catalysts also increases the cost of ion-conducting membranes and therefore it is desirable to maximise the reduction of hydrogen crossover for a given amount of recombination catalyst.

There remains a need to further develop efficient and scalable processes for the production of ion-conducting membranes, and to enhance such membranes to enable efficient operation at high pressure differentials across the membrane.

### SUMMARY OF THE INVENTION

The present inventors have surprisingly found that stabilised dispersions of recombination catalyst nanoparticles may advantageously be combined with ion-conducting polymers to form inks suitable for ion-conducting membrane manufacture, and such inks demonstrate nanoparticle size stability over extended periods of time. The presents inventors have also found that ion-conducting membranes may be produced using such inks which show excellent dispersion of catalyst nanoparticles within a membrane layer.

Therefore, in a first aspect of the invention there is provided a process for producing an ion-conducting membrane comprising a recombination catalyst-containing membrane layer, the process comprising the steps of:
(i) providing a stabilised dispersion of recombination catalyst nanoparticles;
(ii) mixing the stabilised dispersion with an ion-conducting polymer to form an ink;
(iii) fabricating the membrane layer from the ink.

In a second aspect of the invention there is provided an ink for use in the manufacture of an ion-conducting membrane, the ink comprising recombination catalyst nanoparticles, a nanoparticle stabilising agent, and an ion-conducting polymer.

It has also been found that ion-conducting membranes may be produced which comprise a nanoparticle stabilising agent and recombination catalyst nanoparticles dispersed in an ion-conducting polymer layer. Such membranes have been found to provide an enhanced reduction of hydrogen crossover levels during testing as set out in the Examples. Therefore, in a third aspect of the invention there is provided an ion-conducting membrane, such as a proton exchange membrane or an anion exchange membrane, comprising a recombination catalyst-containing membrane layer, the membrane layer comprising dispersed recombination catalyst nanoparticles, a nanoparticle stabilising agent, and an ion-conducting polymer.

Such membranes are particularly suitable for use in a water electrolyser.

The ion-conducting membranes of the third aspect may be obtained or are obtainable by the process of the first aspect.

The ion-conducting membranes of the third aspect have particular utility as a component of a catalyst-coated membrane (CCM). Therefore, in a fourth aspect of the invention there is provided a CCM for an electrochemical device, such as a water electrolyser or a fuel cell, comprising a membrane according to the third aspect.

Suitably, the CCM is for a water electrolyser, such as a PEM water electrolyser. In such cases the CCM comprises a cathode catalyst layer for catalysing a hydrogen evolution reaction and/or an anode catalyst layer for catalysing an oxygen evolution reaction. Typically, the cathode catalyst layer comprises platinum and/or the anode catalyst layer comprises iridium.

The CCM may also be for a fuel cell, such as a PEM fuel cell. In such cases the CCM comprises a cathode catalyst layer for catalysing an oxygen reduction reaction and/or an anode catalyst layer for catalysing a hydrogen oxidation reaction.

In a fifth aspect of the invention there is provided a water electrolyser or a fuel cell comprising a membrane according to the third aspect, or a catalyst-coated membrane according to the fourth aspect.

### BRIEF DESCRIPTION OF THE FIGURES

FIG. 1 shows a schematic representation of an example arrangement of an electrolyte membrane of the invention.

FIG. 2 shows a schematic representation of an example arrangement of a catalyst coated membrane of the invention.

FIG. 3 shows the results of stability testing of an ink comprising PVP-stabilised platinum nanoparticles and an ion-conducting polymer.

FIG. 4 shows the results of Scanning Electron Microscopy-Energy Dispersive X-Ray (SEM_EDX) analysis of a membrane including a platinum-containing membrane layer.

FIG. 5 shows the results of the hydrogen crossover testing of catalyst-coated membranes.

FIG. 6 shows the results of further hydrogen crossover testing of catalyst-coated membranes.

### DETAILED DESCRIPTION

Preferred and/or optional features of the invention will now be set out. Any aspect of the invention may be combined with any other aspect of the invention unless the context demands otherwise. Any of the preferred and/or optional features of any aspect may be combined, either singly or in combination, with any other feature of the invention unless the context demands otherwise.

The present invention provides a process for producing an ion-conducting membrane with a recombination catalyst-containing membrane layer, and ion-conducting membranes including such membrane layers. It may be preferred that the ion-conducting membrane is a proton exchange membrane (PEM), such as a PEM for a water electrolyser. It will however be understood by the skilled person that the process and the recombination catalyst-containing membrane layers described herein also have utility in other types of electrolyte membrane, such as PEM for fuel cells, and anion exchange membranes for water electrolysers, fuel cells or other applications.

The recombination catalyst-containing layer comprises recombination catalyst nanoparticles. The term nanoparticle as used herein relates to a particle with a particle size in the range of and including 1 to 100 nm.

A recombination catalyst is a catalyst which catalyses the reaction between hydrogen gas and oxygen gas to form water. Accordingly, the recombination catalyst used in the ion-conducting membrane of the present invention may be any catalyst capable of catalysing the reaction between hydrogen gas and oxygen gas to form water, thus reducing or preventing the crossover of either hydrogen or oxygen, or both, through the membrane.

Suitably, the recombination catalyst is selected from the list comprising:
i) the platinum group metals (i.e. the group of elements comprising platinum, palladium, iridium, rhodium, ruthenium, and osmium);
ii) gold;
iii) base metals, such as iron, nickel, cobalt or chromium;
iv) an alloy comprising one or more of the above-described elements;
v) mixtures of any of the above.

Suitably, the recombination catalyst comprises platinum or palladium, or consists essentially of platinum or palladium (i.e. the nanoparticles are platinum nanoparticles or palladium nanoparticles). Alternatively, the recombination catalyst may be platinum alloyed with one or more of the above-described elements, for example a platinum-palladium alloy, a platinum-iridium alloy, a platinum cobalt alloy or a platinum-ruthenium alloy.

Preferably, the recombination catalyst nanoparticles in the dispersion are unsupported. The term unsupported will be readily understood by the skilled person. For example, it will be understood that the recombination catalyst particles are not bound or fixed to a solid catalyst support, such as a carbon support, by physical or chemical bonds, e.g. by way of ionic or covalent bonds, or non-specific interactions such as Van der Waals forces. The use of unsupported nanoparticles offers increased membrane stability during electrochemical operation, avoiding routes of degradation via corrosion or other chemical or electrochemical reactions of the catalyst support, and enables greater dispersion within the membrane layer.

The process comprises the step of (i) providing a stabilised dispersion of recombination catalyst nanoparticles. It will be understood by the skilled person that a stabilised nanoparticle dispersion comprises solid catalyst nanoparticles in a liquid phase comprising at least one nanoparticle stabilising agent which interacts with the nanoparticles to prevent nanoparticle agglomeration. Such agents additionally act as a capping agent during synthesis.

The process as described herein involves a first step of forming a stabilised nanoparticle dispersion prior to a step of mixing the stabilised dispersion with an ion-conducting polymer in a subsequent ink forming step. It will therefore be understood by the skilled person that the or each stabilising agent used to form the stabilised nanoparticle dispersion is not the same as the ion-conducting polymer used in step (ii) to form the ink.

Suitable nanoparticle stabilising agents are selected from those agents which interact with the catalyst nanoparticle surface, preventing aggregation and coalescence of the catalyst nanoparticles, and enabling the formation of a nanoparticle dispersion. Such stabilisation of the nanoparticle surface is typically through interaction between the nanoparticle with a polar functional group of the stabilising agent. Typically, the stabilising agent comprises an amide, carboxylic acid, sulphonic acid, amine, alcohol, or ether functional group. It may be preferred that the stabilising agent comprises an amide or an ether functional group. It may be further preferred that the stabilising agent comprises a tertiary amide group. In some embodiments the stabilising agent does not have acidic functional groups. In some embodiments the stabilising agent does not have sulfonic acid functional groups. Preferably, the nanoparticle stabilising agent is water-soluble, such as a water-soluble polymer. It is preferred that the nanoparticle stabilising agent has a water solubility at 25° C. of at least 1 mg/mL, preferably at least 10 mg/mL, or more preferably at least 100 mg/mL.

It may be preferred that the stabilising agent has a greater hydrophobicity and/or a lower water uptake value than the ion-conducting polymer used in step (ii).

Suitably, the stabilised dispersion comprises a polymeric nanoparticle stabilising agent. It may be preferred that the stabilised dispersion comprises a polymeric nanoparticle stabilising agent with a greater hydrophobicity and/or a lower water uptake value than the ion-conducting polymer used in step (ii). It may also be preferred that the polymeric nanoparticle stabilising agent has a lower weight average molecular weight than the ion-conducting polymer used in step (ii).

It may be further preferred that the polymeric stabilising agent comprises amide functional groups, such as tertiary amide functional groups, for example pyrrolidone functional groups (such as polyvinylpyrrolidone (PVP), or copolymers including vinylpyrrolidone as a first polymerisation unit).

Suitably, the stabilising agent is polyvinylpyrrolidone (PVP). The use of PVP has been found to provide excellent dispersion stability in the presence of perfluorosulphonic (PFSA) acid polymers, and greater nanoparticle dispersion stability than nanoparticles with PFSA alone.

Suitably, the stabilising agent is PVP with a weight average molecular weight in the range of and including 5,000 to 50,000. Such a range is considered to provide a suitable balance between dispersion stability and ease of polymer processability. It may be further preferred that the polymeric stabilising agent is polyvinylpyrrolidone with a weight average molecular weight in the range of and including 8,000 to 45,000.

Typically, the stabilised dispersion is formed in an aqueous medium, such as water.

Suitably, the recombination catalyst nanoparticles are present in the dispersion in an amount in the range of any including 0.5 to 10 g L⁻¹, for example in the case that the recombination catalyst nanoparticles are platinum particles such particles are typically present in an amount in the range of any including 0.5 to 10 g_{Pt} L⁻¹. The nanoparticle concentration may be adjusted using techniques known to the skilled person, such as evaporation or cross-flow filtration.

Suitably, the dispersion formed in step (i) has a zeta potential more positive than +25 mV or more negative than −25 mV. The zeta potential may be measured using electrophoretic light scattering, for example using a Zetasizer Ultra (Malvern Panalytical).

The skilled person will be aware of methods for the production of suitable catalyst nanoparticle dispersions. For example, dispersions may be produced by continuous flow hydrothermal synthesis. Suitably, such synthesis may be carried out in mixing reactors such as those described in WO2015075439A1 (The University of Nottingham) which is incorporated herein by reference.

Catalyst nanoparticle dispersions may also be produced by mixing a suitable catalyst precursor with the stabilising agent in a solvent, such as water and then forming the nanoparticles in situ. For example, in the case of platinum nanoparticles, dispersions may be produced by mixing a platinum precursor, such as chloroplatinic acid (H₂PtCl₆), Pt nitrate or Pt (acac), with the stabilising agent in a solvent, such as water, and then reducing the platinum precursor, for example using sodium borohydride or formaldehyde. An example of such a preparation is described in Du, Y. K., Journal of Applied Polymer Science, Vol. 99, 23-36 (2006) which is incorporated herein by reference.

The process comprises the step of (ii) mixing the stabilised dispersion with an ion-conducting polymer to form an ink. Typically, this is achieved by forming a dispersion of the ion-conducting polymer and then mixing this dispersion with the stabilised dispersion of recombination catalyst nanoparticles.

The skilled person will be aware of suitable ion-conducting polymers for the preparation of ion-conducting membranes. The ion-conducting polymer can be a proton-conducting polymer or an anion-conducting polymer, such as a hydroxyl anion-conducting polymer. Examples of suitable proton-conducting polymers include perfluorosulphonic acid ionomers (e.g. Nafion® (Chemours Company), Aciplex® (Asahi Kasei), Aquivion™ (Solvay Speciality Polymers), Flemion® (Asahi Glass Co.), or ionomers based on a sulphonated hydrocarbon such as those available from FuMA-Tech GmbH as the fumapem® P, E or K series of products (JSR Corporation, Toyobo Corporation, and others). Examples of suitable anion-conducting polymers include A901 and A201 made by Tokuyama Corporation, Fumasep FAA from FuMA-Tech GmbH, and Aemion polymers from Ionomr.

In cases in which the membrane is for a PEM electrochemical device, the ion-conducting polymer is suitably a proton conducting polymer, and in particular a partially- or fully-fluorinated sulphonic acid polymer. Examples of suitable proton-conducting polymers include perfluorosulphonic (PFSA) acid polymers. It may be preferred that the ion-conducting polymer is a PFSA polymer and has an equivalent weight (EW) greater than 750 EW, greater than 760 EW, greater than 770 EW, or greater than 790 EW. For example, it may be preferred that the ion-conducting polymer is a PFSA polymer with an equivalent weight in the range of and including 750 to 1200 EW, such as in the range of and including 770 to 1000 EW, or 800 to 900 EW.

The ion-conducting polymer is typically dispersed in a mixture of an organic solvent and water. For example, the solvent may be a mixture of an alcohol (e.g. ethanol or propanol) and water. The volume ratio of organic solvent, such as ethanol, to water may be in the range of and including 95:5 to 60:40, such as in the range of and including 90:10 to 70:30. The solvent is formulated for achieving the desired dispersion, coating, and drying characteristics.

The ink may also comprise a radical reducing additive (e.g., a peroxide radical reducing additive, such as ceria). For example, the radical reducing additive (such as ceria) may be provided in the dispersion at a weight percentage, relative to the weight of ion-conducting polymer, in the range of and including 0.15 wt % to 0.35 wt %, such as in the range of and including 0.20 to 0.30 wt %. The radical reducing agent is typically added to the ink once the stabilised dispersion is mixed with the ion-conducting polymer.

The formed ink typically comprises, or consists essentially of:
(i) an ion-conducting polymer, such as a proton-conducting polymer, for example a PFSA ionomer. The ion-conducting polymer is typically provided in the ink at a weight percentage, with respect to the total weight of the ink components, in the range of and including 5 wt % to 25 wt %, such as in the range of and including 10 wt % to 20 wt %;
(ii) recombination catalyst nanoparticles, such as palladium or platinum nanoparticles. Typically the catalyst nanoparticles are present in the ink in an amount, with respect to the total weight of the ink components, in the range of and including 0.01 to 0.40 wt %, such as platinum nanoparticles in the range of and including 0.01 to 0.40 wt % Pt;
(iii) a nanoparticle stabilising agent, such as a polymeric nanoparticle stabilising agent, for example PVP. Typically, the nanoparticle stabilising agent is present in the ink in an amount, with respect to the total weight of the ink components, in the range of and including 0.05 to 2 wt % such as 0.05 to 0.50 wt %;
(iv) optionally, a radical reducing additive, such as ceria (CeO₂), typically in an amount at a weight percentage, with respect to the total weight of the ink components, in the range in the range of and including 0.15 wt % to 0.35 wt %.
   with components (i) to (iv) dispersed in a solvent, such as a mixture of an alcohol (e.g. ethanol or 1-propanol) and water, for example in a volume ratio of alcohol:water: 95:5 to 60:40.

The process comprises the step of (iii) fabricating the membrane layer from the ink. The membrane layer is typically formed by depositing the ink onto a substrate to form the layer.

The coating composition may be deposited using a slot-die coating process (whereby the dispersion is squeezed out by gravity or under pressure via a slot onto the substrate), knife-coating, bar coating, inkjet printing, curtain coating, spray coating, or casting processes. Preferably, the coating composition can be deposited using slot-die coating, bar coating, or inkjet printing. Deposition using slot-die coating may be particularly preferred.

The coating composition is deposited onto a substrate to form a membrane layer. In some cases, the ion-conducting membrane is formed from a single membrane layer. Alternatively, the ion-conducting membrane may be formed from two or more layers, such as between two and seven layers. The number of layers will be determined, for example, by the thickness of the desired membrane, and the degree of variation in desired composition across the membrane (for example the membranes may contain one or more layers comprising a reinforcement polymer, such as ePTFE, or an additive, such as a radical reducing additive).

Typically, the substrate is a backing sheet, an ion-conducting layer, a catalyst layer on a backing sheet, or a catalyst layer on a gas diffusion electrode. It will be understood by the skilled person that the choice of substrate will depend on the structure and stage of production of the membrane.

In the case that the membrane is formed of a single membrane layer, or at the start of production of a multi-layer membrane, the substrate is typically a backing layer. The backing layer provides support for the ion-conducting membrane during manufacture and if not immediately removed, can provide support and strength during any subsequent storage and/or transport. The material from which the backing layer is made should provide the required support, preferably be compatible with the ink, preferably be impermeable to the ink, be able to withstand the process conditions involved in producing the ion-conducting membrane and be able to be easily removed without damage to the ion-conducting membrane. Examples of materials suitable for use include a fluoropolymer, such as polytetrafluoroethylene (PTFE), ethylene tetrafluoroethylene (ETFE), perfluoroalkoxy polymer (PFA), fluorinated ethylene propylene (FEP—a copolymer of hexafluoropropylene and tetrafluoroethylene), and polyolefins, such as biaxially oriented polypropylene (BOPP).

In some cases in which a catalyst-coated membrane is to be produced, a catalyst layer is provided on a backing layer, for example by printing or using known coating techniques. The coating composition may then be deposited onto the catalyst layer such that the catalyst layer is disposed between the backing layer and the membrane layer formed by depositing the ink.

In some cases, typically when the ion-conducting membrane thickness is such that multiple passes are required in order to build up the membrane structure, the substrate is a previously formed membrane layer. It will be understood that the ion-conducting membrane may be formed by sequential deposition of layers. As an example, ion-conducting membranes may be formed as follows. In the first pass, an ink containing an ion-conducting polymer may be deposited onto a backing layer to form a first ion-conducting polymer layer, which is then dried. In a second pass, an ink is deposited onto the first ion-conducting polymer layer to form a second ion-conducting polymer layer. The second ion-conducting polymer layer is then dried. This sequence of application and drying is continued to produce further ion-conducting polymer layers as required to form the desired membrane structure. It will be understood by the skilled person that the recombination catalyst-containing ink as described hereinbefore is used in one or more of the coating passes as required by the final membrane structure.

The membranes formed by the method as described herein may be used in the production of catalyst-coated membranes. In such cases, the method may comprise the step of forming a catalyst layer on the first and/or the second face of the membrane to form an anode and/or a cathode. The skilled person will understand that the specific type of catalysts for the cathode and anode are chosen depending on, for example, whether the membrane is for a fuel cell or an electrolyser and whether the membrane is a PEM or an AEM as described previously. Furthermore, the method of deposition can be varied, for example catalyst layers may be transferred to the membrane from a decal, for example by hot pressing, or catalyst inks may be directly printed onto the membrane.

The present invention also provides ion-conducting membranes, such as PEM or AEM, comprising a recombination catalyst-containing membrane layer which comprises dispersed recombination catalyst nanoparticles. Such membranes are particularly suitable for electrolyser applications. The ion-conducting membranes may be obtained or are obtainable by a process as described hereinbefore.

Typically, the ion-conducting membranes have a thickness of less than or equal to 100 μm. It may be preferred that the membrane has a thickness of less than or equal to 95 μm, 90 μm, or 85 μm. It may be preferred that the membrane has a thickness of at least 10 μm, such as at least 15 μm, at least 20 μm, at least 25 μm, at least 30 μm or at least 40 μm. It may be further preferred that the membrane has a thickness in the range of and including 10 to 100 μm, such as 15 to 100 μm, 20 to 100 μm, 30 to 100 μm, 30 to 90 μm, or 40 to 90 μm.

The ion-conducting membrane thickness (and the thickness of layers of the membranes) may be measured by scanning electron microscopy (SEM) at 0% relative humidity. SEM analysis is carried out on cross sections of the membrane and the membrane and/or layer thickness measured at multiple (for example 10) points. The thickness values are then determined by calculating the arithmetic mean of the measured values. Typically, the SEM measurement is carried out on a cross section of the membrane which is embedded in resin, ground and polished.

The ion-conducting membranes comprise a recombination catalyst-containing membrane layer. It will be understood by the skilled person that the membrane may comprise more than one recombination catalyst-containing membrane layers, such as two or more recombination catalyst-containing membrane layers. It may be preferred that the membrane has a single recombination catalyst-containing membrane layer.

The recombination catalyst nanoparticles are dispersed in the membrane layer. The membrane layer also comprises an ion-conducting polymer and nanoparticle stabilising agent, each suitably as described hereinbefore with reference to the process. By dispersed in the membrane layer it is meant herein that the nanoparticles are distributed throughout the membrane layer, i.e. they are not located in a discrete region of this layer such as on the surface of a reinforcement component. The skilled person will understand that the term ‘dispersed’ does not preclude clustering of the nanoparticles, although in such cases the clusters are themselves distributed throughout the membrane layer.

Suitably, the recombination catalyst nanoparticles have an average size less than 50 nm, such as in the range of and including 1 to 50 nm. It may be preferred that the recombination catalyst nanoparticles have an average size in the range of and including 1 to 40 nm, 1 to 30 nm, 1 to 20 nm, or 1 to 10 nm. The average particle size of recombination catalyst nanoparticles in the membrane may be determined by transmission electron microscopy (TEM), for example analysing a cross section of the membrane by TEM and, from the resulting image, measuring the size of a population of (e.g. 100) particles by image analysis and then calculating the average (mean) value.

Typically, the recombination catalyst nanoparticles are substantially in the form of clusters of discrete nanoparticles. In such cases the nanoparticles are present in the form of individual nanoparticles which are co-located in clusters, and not in the form of nanoparticle aggregates or agglomerates in which the nanoparticles are bonded together through nanoparticle surface-nanoparticle surface interactions. Without being bound by theory, it is proposed that such as arrangement of nanoparticles may offer benefits associated with greater accessibility for hydrogen to reach catalytic sites. Typically, the clusters have an average size in the range of and including 100 to 500 nm. The average particle size of the clusters of recombination catalyst nanoparticles in the membrane may be determined by transmission electron microscopy (TEM), for example analysing a cross section of the membrane by TEM and, from the resulting image, measuring the size of a population of (e.g. 100) clusters by image analysis and then calculating the average (mean) value.

The membrane layer comprises a nanoparticle stabilising agent as hereinbefore described, such as a polymeric nanoparticle stabilising agent, for example polyvinylpyrrolidone. Typically, the recombination catalyst nanoparticles are at least partially coated with the nanoparticle stabilising agent.

As described hereinbefore, it may be preferred that nanoparticle stabilising agent has a greater hydrophobicity and/or a lower water uptake value than the ion-conducting polymer used in the recombination-catalyst containing membrane layer. Without being bound by theory, the use of a nanoparticle stabilising agent with a higher hydrophobicity and/or lower water uptake value than the ion-conducting polymer has the potential to improve recombination catalyst efficiency by increasing the rate of hydrogen gas access to the surface of the recombination-catalyst nanoparticles and facilitating removal of formed water from the catalyst surface. This offers increased rates of recombination of hydrogen and oxygen and therefore enhanced protection from hydrogen crossover for a given catalyst loading in the membrane. The water uptake value of the ion-conducting polymer and the nanoparticle stabilising agent may be determined by drying a sample of material and then measuring the weight of the sample before and after immersion in water (e.g. at 23° C. for 24 hours). For example the water uptake value may be measured by (i) drying a sample in an oven until the weight stabilises; (ii) cooling the sample in a desiccator; (iii) weighing the sample; (iv) immersing the sample in water (e.g. at 23° C. for 24 hours); (iv) removing the sample and patting dry with a lint free cloth; and (v) re-weighing the samples.

Preferably, the ion-conducting membrane has a recombination catalyst (e.g. platinum) loading in the range of and including 1 to 30 μg/cm⁻², such as in the range of and including 5 and 25 μg/cm⁻², or in the range of and including 8 and 15 μg/cm⁻², or in the range of 1 to 10 μg/cm⁻², or in the range of 1 to 5 μg/cm⁻². It has been found that this range of catalyst loading provides a suitable balance between reducing the level of hydrogen crossover during use and the cost associated with the inclusion of catalyst in the membrane. The catalyst loading may be determined by inductively coupled plasma mass spectrometry (ICP-MS).

Typically, the recombination-containing membrane layer has a thickness in the range of and including 5 to 30 μm. The dispersion of nanoparticles in a membrane layer of at least 5 μm offers improved membrane stability benefits in comparison with the use of thinner catalyst layer, e.g. applied to a membrane surface. The use of a recombination-containing membrane layer with a thickness greater than 30 μm is not required to substantially reduce hydrogen crossover and can provide manufacturing difficulties, in particular when forming non-laminated membrane structures. The thickness of the membrane layer may be determined by SEM analysis of a cross-section of the membrane as hereinbefore described. It may be preferred that the recombination catalyst-containing membrane layer has a thickness in the range of and including 5 to 20 μm, such as between 7 and 15 μm. Such thicknesses offer a suitable balance between the reduction of hydrogen crossover by the formed membrane and manufacturing efficiency.

It is preferred that the membrane is formed by methods that do not require lamination steps to form the membrane, for example by depositing multiple layers of ion-conductive polymer on top of each other via a liquid phase deposition process such as printing, spraying, or coating.

It is preferred that the membrane is a single coherent polymer film comprising a plurality of ion-conducting polymer layers. The term ‘coherent’ as used herein means that the membrane is free from internal lamination interfaces.

Lamination of ion-conductive membranes comprises pressing and/or bonding at least two solid ion-conductive membranes together, such membranes optionally being coated with a catalyst layer. A lamination interface is formed between the two membranes where solid surfaces of the individual membranes are pressed and/or bonded together. Lamination interfaces comprise physical defects. Furthermore, the structural and/or chemical nature of a lamination interface also differs from that of the bulk polymer material. This is because when a solid membrane is formed, the outer surfaces of the solid membrane have surface features which are distinct from those in the bulk material. For example, a hydrophobic skin forms on a surface of a membrane at an air interface. Raman spectroscopy can detect this difference. As such, when two solid membranes are pressed together, the lamination interface formed by the two solid surfaces is distinctive in chemical and/or structural form compared to the bulk of the ion-conductive polymer material. Microscopy and spectroscopy techniques can thus distinguish between lamination interfaces between layers of ion-conductive polymer and interfaces which have been formed via a liquid phase deposition process such as printing, spraying, or coating of layers to build up a multi-layer structure. That is, a non-laminated interface is structurally and/or chemically distinct from a laminated interface and is not just a feature of the manufacturing method. Furthermore, a non-laminated interface can be identified as being non-laminated in a membrane without prior knowledge of the manufacturing method. Examples of analysis techniques for detecting a laminated interface include cross-section SEM. Variations of crystallinity at interfaces can be detected using cross-section TEM. Other techniques for detecting laminated interfaces include 13C/1H/19F solid state NMR, neutron diffraction, and/or a combination of two or more of the aforementioned techniques.

Due to physical defects and/or chemical variations at lamination interfaces between ion conductive polymer membranes, such interfaces can increase the resistance of a multi-layer ion conductive membrane. As such, it has been found to be advantageous to fabricate a multi-layer ion conductive membrane by depositing layers of ion-conducting polymer dispersed in a liquid solvent to build up a multi-layer membrane structure rather than via lamination of individual solid layers/membranes of ion conductive polymer.

Preferably, the membrane comprises a reinforcement polymer, such as expanded polytetrafluoroethylene (ePTFE) or polybenzimidazole (PBI). It may be preferred that the recombination-containing membrane layer does not comprise a reinforcement polymer.

The reinforcement material may comprise a porous reinforcement polymer sheet which is impregnated with ion-conducting polymer, the reinforcement material optionally being expanded polytetrafluoroethylene (ePTFE). As typical reinforcement polymer materials are not conductive to ions, or not sufficiently conductive to ions, the reinforcement layer is thus formed using a porous reinforcement polymer which is impregnated with ion-conducting polymer through the pores of the material to provide ion-conductive paths from one side of the layer to the other side of the layer.

Preferably, the membrane comprises a radical reducing additive (e.g. peroxide radical reducing additive, such as ceria). It will be noted that peroxide can decompose to form a range of radicals (O, OH, OOH) and the radical reducing additive may reduce the amount of one, more, or all of these radicals. The radical reducing additive may be dispersed within the recombination-containing membrane layer.

Typically, the membrane is configured such that, referring to FIG. 1, the recombination catalyst-containing membrane layer (1) is disposed between a first ion-conducting polymer layer (2) and a second ion-conducting polymer layer (3). In such configurations, the second face (4) of the first ion-conducting polymer layer (2) and the second face (5) of the second ion-conducting polymer layer (3) each face inwards, towards the recombination catalyst-containing membrane layer (1). The first face (6) of the first ion-conducting polymer layer (2) and the first face (7) of the second ion-conducting polymer layer (3) are the outer surfaces of the membrane, i.e. facing towards the anode and the cathode when incorporated into, for example, a water electrolyser.

Suitably, the membrane consists of a recombination catalyst-containing membrane layer disposed between a first ion-conducting polymer layer and a second ion-conducting polymer layer. It will be understood by the skilled person that the first ion-conducting polymer layer and a second ion-conducting polymer layer may be formed from one or more sub-layers, which may be of the same or different composition.

In cases in which the membrane is for a PEM electrochemical device, the ion-conducting polymer present in the first and second ion-conducting polymer layers is suitably a proton conducting polymer and in particular a partially- or fully-fluorinated sulphonic acid polymer. Examples of suitable proton-conducting polymers include the perfluorosulphonic acid ionomers. It may be preferred that the ion-conducting polymer in the first and/or the second ion-conducting layers is the same as the ion-conducting polymer in the recombination catalyst-containing membrane layer. It may alternatively be preferred that the ion-conducting polymer in the first and/or the second ion-conducting layers is different to the ion-conducting polymer in the recombination catalyst-containing membrane layer.

Typically, a reinforcement polymer and/or a radical reducing agent (e.g. a peroxide radical reducing additive, such as ceria) is present in the first and/or the second ion-conducting polymer layer.

It may be preferred that the thickness of the first ion-conducting polymer layer is less than the thickness of the second ion-conducting polymer layer. This asymmetry enables the recombination catalyst-containing membrane layer to be placed closer to the anode than the cathode in a water electrolyser configuration, which is considered beneficial for the reduction in hydrogen crossover.

It may be preferred that the first ion-conducting polymer layer has a thickness in the range of and including 5 to 30 μm, such as in the range of and including 5 to 20 μm, or from 5 to 15 μm, or 7 to 15 μm. Such a thickness for the first ion-conducting polymer layer is considered by the present inventors to provide a suitable distance between the anode layer and the recombination catalyst in a formed CCM for a water electrolyser to provide a significant reduction in hydrogen crossover.

It may be preferred that the second ion-conducting polymer layer has a thickness in the range of and including 10 to 90 μm, such as in the range of and including 20 to 70 μm, 40 to 70 μm, or 25 to 45 μm.

The thickness of the ion-conducting polymer layers may be adjusted, for example, by varying the number of multiple deposition passes of ion-conducting polymer during manufacture of the membrane, or by variation in the pump speed during deposition of ion-conducting polymer.

It may be preferred that the membrane comprises or consists of (i) a first ion-conducting layer with a thickness in the range of and including 5 to 15 μm; (ii) a second ion-conducting layer with a thickness in the range of and including 25 to 45 μm; and (iii) a recombination catalyst-containing membrane layer with a thickness in the range of and including 5 to 15 μm, and which is disposed between the first ion-conducting layer and the second ion-conducting layer. In such configurations it is preferred that the second ion-conducting layer comprises a reinforcement polymer, such as expanded polytetrafluoroethylene (ePTFE) or polybenzimidazole (PBI). Such a membrane structure provides has been found to provide a particularly suitable balance between membrane resistance and level of hydrogen crossover.

It may be preferred that the membrane comprises consists of (i) a first ion-conducting layer with a thickness in the range of and including 5 to 15 μm; (ii) a second ion-conducting layer with a thickness in the range of and including 40 to 70 μm; and (iii) a recombination catalyst-containing membrane layer with a thickness in the range of and including 5 to 15 μm and which is disposed between the first ion-conducting layer and the second ion-conducting layer. In such configurations it is preferred that the second ion-conducting layer comprises a reinforcement polymer, such as expanded polytetrafluoroethylene (ePTFE) or polybenzimidazole (PBI). It may be further preferred that the second ion-conducting layer contains two regions of reinforcement polymer, such as two sub-layers comprising a reinforcement polymer, such as expanded polytetrafluoroethylene (ePTFE) or polybenzimidazole (PBI). Such a membrane structure enables operation at particularly high gas pressure differentials across the membrane whilst maintaining hydrogen crossover and low membrane resistance.

The membranes as described herein may suitably be used as part of a catalyst-coated membrane (CCM). Such CCMs have an anode catalyst layer and/or a cathode catalyst layer applied to a face of the membrane. The membranes also have utility in systems in which one or more of the anode and the cathode catalyst layers are applied to substrates positioned either side of the membrane, such as gas diffusion layers or porous transport layers.

In the case of a CCM for a water electrolyser, a cathode catalyst layer may be applied to a surface of the membrane comprising a catalyst for catalysing the hydrogen evolution reaction. It may be preferred that the cathode catalyst layer comprises platinum, for example a platinum-on-carbon catalyst. The catalyst material can be formulated into an ink, printed ex-situ onto a PTFE sheet, and transferred onto the membrane by hot pressing. Alternatively, the ink can be directly coated onto the membrane.

In the case of a CCM for a water electrolyser, an anode catalyst layer may be applied to a surface of the membrane comprising a catalyst for catalysing the oxygen evolution reaction.

In the case that the CCM is for a PEMWE, it may be preferred that the anode catalyst layer comprises iridium, such as iridium oxide or mixed oxides of iridium and another metal or metals.

The anode material can be formulated into an ink, suitably in an ion-conducting polymer, printed ex-situ onto a PTFE sheet, and transferred onto the membrane by hot pressing. Alternatively, the ink can be directly coated onto the membrane.

Typically, the CCM comprises a membrane which comprises a first ion-conducting polymer layer and a second ion-conducting polymer layer with the recombination catalyst-containing membrane layer disposed between the first and second ion-conducting polymer layers as described hereinbefore. It is preferred that CCM is configured such that the recombination catalyst-containing membrane layer is closer to the anode catalyst layer than the cathode catalyst layer. It may be further preferred that the thickness of the second ion-conducting polymer layer is greater than the thickness of the first ion-conducting polymer layer Such a configuration is proposed to have benefits with regards to reduction of hydrogen crossover.

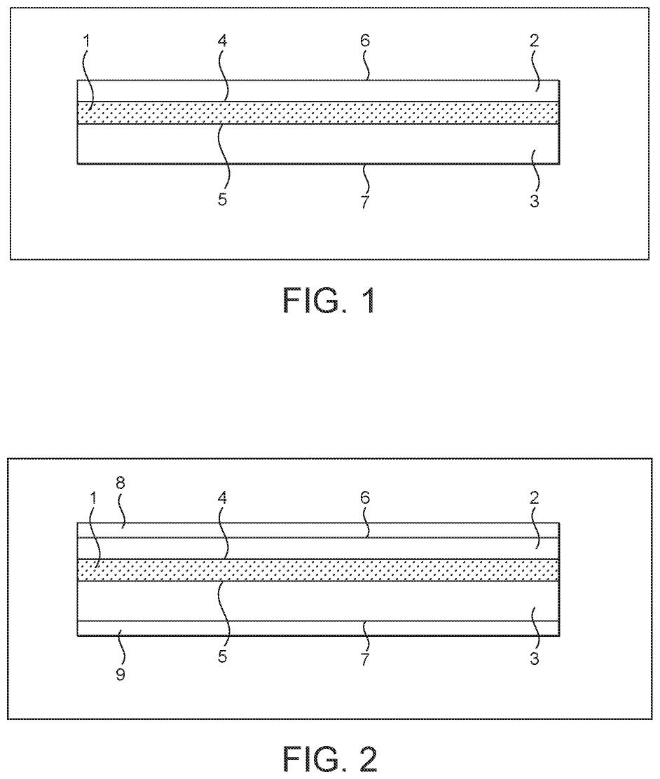

Suitably, the CCM is configured such that, referring to FIG. 2, the second face (4) of the first ion-conducting polymer layer (2) and the second face (5) of the second ion-conducting polymer layer (3) each face inwards, towards the recombination catalyst-containing membrane layer (1). The anode catalyst layer (8), if present, is provided on the first face (6) of the first ion-conducting polymer layer (2). The cathode catalyst layer (9), if present, is provided on the first face (6) of the second ion-conducting polymer layer (3).

It may be preferred that the catalyst coated membrane comprises a membrane which comprises or consists of (i) a first ion-conducting layer with a thickness in the range of and including 5 to 15 μm; (ii) a second ion-conducting layer with a thickness in the range of and including 25 to 45 μm; and (iii) a recombination catalyst-containing membrane layer with a thickness in the range of and including 5 to 15 μm and which is disposed between the first ion-conducting layer and the second ion-conducting layer, and wherein the second face of the first ion-conducting polymer layer and the second face of the second ion-conducting polymer layer each face inwards, towards the recombination catalyst-containing membrane layer, and wherein an anode catalyst layer as described hereinbefore is provided on the first face of the first ion-conducting layer and/or a cathode catalyst layer as described hereinbefore is provided on the first face of the second ion-conducting layer. In such configurations it is preferred that the second ion-conducting layer comprises a reinforcement polymer, such as expanded polytetrafluoroethylene (ePTFE) or polybenzimidazole (PBI).

It may be preferred that the catalyst coated membrane comprises a membrane which comprises or consists of (i) a first ion-conducting layer with a thickness in the range of and including 5 to 15 μm; (ii) a second ion-conducting layer with a thickness in the range of and including 40 to 70 μm; and (iii) a recombination catalyst-containing membrane layer with a thickness in the range of and including 5 to 15 μm and which is disposed between the first ion-conducting layer and the second ion-conducting layer, and wherein the second face of the first ion-conducting polymer layer and the second face of the second ion-conducting polymer layer each face inwards, towards the recombination catalyst-containing membrane layer, and wherein an anode catalyst layer as described hereinbefore is provided on the first face of the first ion-conducting layer and/or a cathode catalyst layer as described hereinbefore is provided on the first face of the second ion-conducting layer. In such configurations it is preferred that the second ion-conducting layer comprises a reinforcement polymer, such as expanded polytetrafluoroethylene (ePTFE) or polybenzimidazole (PBI). It may be further preferred that the second ion-conducting layer contains two regions of reinforcement polymer, such as two sub-layers comprising a reinforcement polymer, such as expanded polytetrafluoroethylene (ePTFE) or polybenzimidazole (PBI).

The present invention will now be described with reference to the following examples, which are provided to assist with understanding the present invention and are not intended to limit its scope.

### EXAMPLES

### Example 1—Formation of a Stabilised Dispersion of Platinum Nanoparticles Using PVP

A PVP-stabilised dispersion of platinum nanoparticles in water was prepared from aqueous platinum nitrate solution and a 2 w/v % aqueous PVP (MW 10,000) solution using a continuous flow hydrothermal reactor operating at elevated temperature and pressure. The Pt loading in the dispersion measured using ICP was 3.93 g/L.

Analysis by dynamic light scattering (DLS) indicated that the z-average value of PVP-Pt clusters in the dispersion is 280 nm with small-angle X-ray scattering (SAXS) analysis indicating that the size of platinum nanoparticles is in the range 1 to 10 nm.

### Example 2—Formation of an Ink Comprising PVP-Stabilised Platinum Nanoparticles and an Ion-Conducting Polymer

The aqueous dispersion prepared in Example 1 was mixed with additional water and EtOH to create an ethanol in water mix (wt % ratio 4:1). Dry PFSA ionomer (3M Corporation, EW-800) is added to create a ˜17 wt % ionomer and 0.08 wt % Pt ink. The ink was mixed using a roller mixer.

Analysis by dynamic light scattering (DLS) indicated that the z-average diameter of the Pt-PVP clusters in the dispersion is 1200 nm.

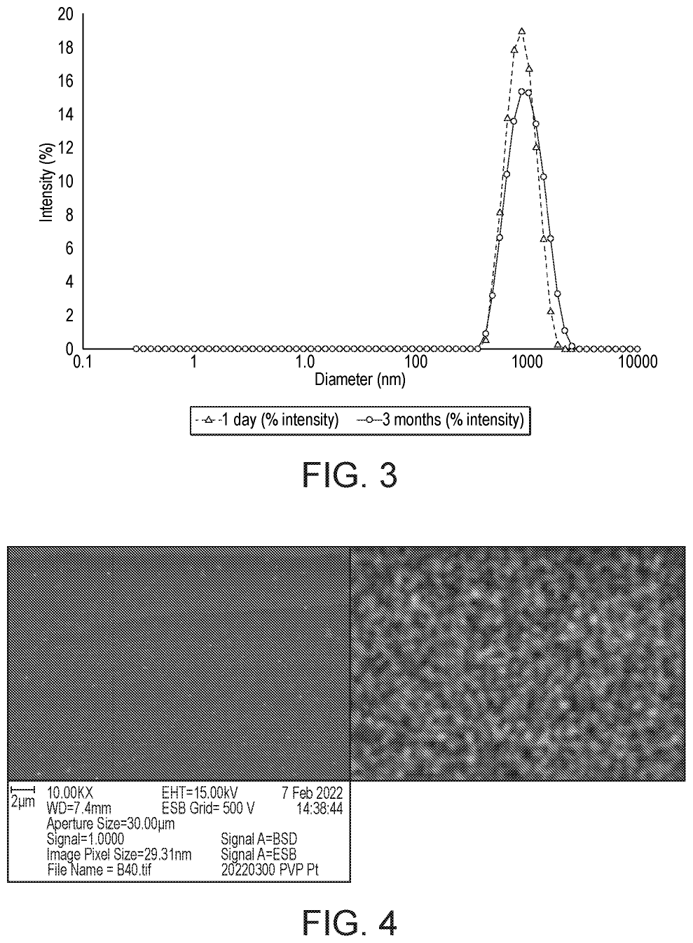

The stability of the ink during storage was assessed by measuring the z-average diameter after 1 day and after 3 months. The results are shown in FIG. 3 which show no change in the DLS analysis profile indicating high stability and resistance to agglomeration.

### Example 3—Preparation of a Membrane Including a Platinum-Containing Membrane Layer

A membrane containing a platinum-containing membrane layer was prepared by knife coating a layer of an ink prepared in accordance with the method of Example 2 onto a 15 μm thick PFSA membrane and drying the formed layer at room temperature.

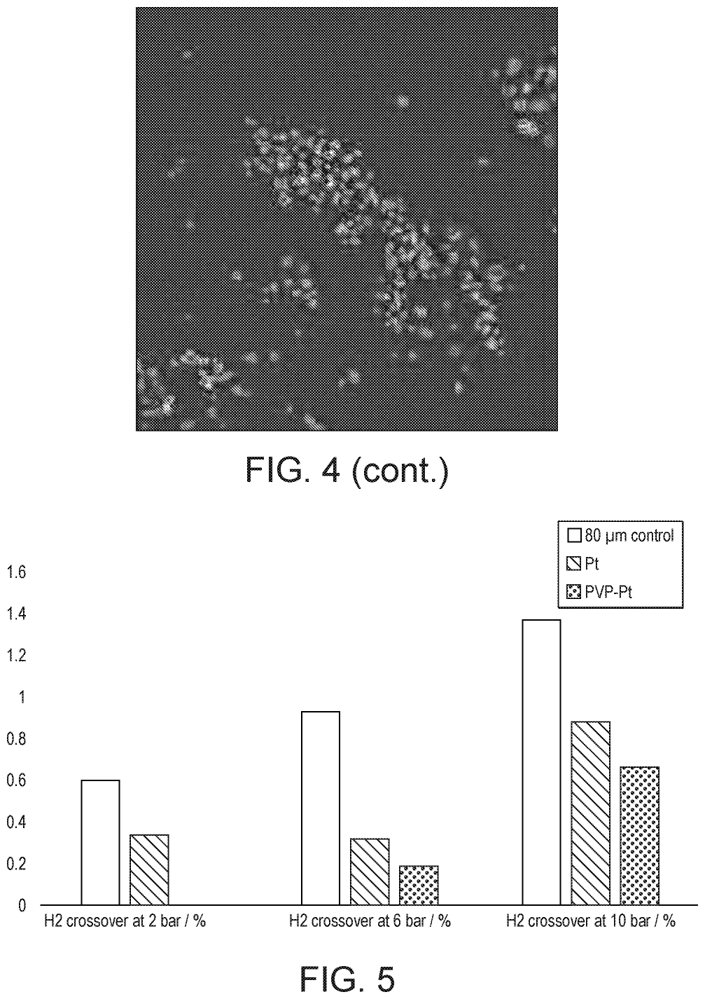

A cross-section of the formed membrane was analysed by Scanning Electron Microscopy with Energy Dispersive X-Ray Analysis (SEM-EDX). This showed that the platinum-containing membrane layer had a thickness of around 30 μm. An expanded section of an SEM-EDX image of the platinum-containing membrane layer is shown in FIG. 4. This indicates that nanoparticles of platinum were distributed throughout the membrane layer.

### Example 4—Preparation of a Membrane Including a Platinum-Containing Membrane Layer and Analysis by Cryo-TEM

An ink prepared in accordance with Example 2, was frozen using liquid nitrogen in the cryo-microtome and cut using a diamond knife in sections. One section is placed on the copper grid and thawed, forming a <100 nm thick film.

The formed membrane was analysed by cryo-transmission electron microscopy (cryo-TEM). This analysis indicates that the platinum nano-particles in the membrane have an average particle size in the range of 1 to 10 nm and are in the form of clusters of discrete nano-particles of Pt.

An algorithm was used to measure the average nearest neighbour distance between platinum particles from the cyro-TEM images. This data was compared to an analysis of a comparative membrane incorporating a platinum-containing membrane layer with the same Pt loading but prepared from an ink containing Pt particles from a platinum black source without any stabilising agent. This indicated a significant reduction in interparticle distance when the membrane is formed from the stabilised nanoparticle dispersion and therefore increased Pt dispersion in the membrane layer.

### Example 5—Formation of CCMs Incorporating Membranes With a Platinum-Containing Membrane Layer and Hydrogen Cross Over Testing

A composite membrane of thickness ˜105 μm was prepared by casting a 10 μm recombination catalyst layer (using the method described in Example 3) onto an 80 μm PFSA membrane, and then laminating the product onto a 15 μm thick PFSA membrane so that the recombination catalyst layer was positioned between the two PFSA membranes. CCMs were obtained by laminating a Pt/C cathode catalyst layer (with a Pt loading of 0.4 mg cm⁻² of Pt) and an IrOx anode catalyst layer (with an Ir loading of 2 mg cm⁻²) on either side of the composite membrane. Lamination was achieved by hot-pressing at 173° C. and 800 PSI for 2 mins.

Also prepared were Comparative Examples of CCMs with the same catalyst layers formed on (i) an 80-micron PFSA membrane without any recombination catalyst (“80 μm control” in FIG. 5) and (ii) a membrane as prepared in Example 5 but with a recombination catalyst layer formed from an ink to which Pt particles were added (without the use of a stabilised dispersion of nanoparticles, “Pt” in FIG. 5).

### Testing of Catalyst Coated Membranes (CCMs)

### Hydrogen Crossover

The level of hydrogen crossover for each CCM was measured at different pressures using the following method:

A water electrolysis cell was prepared incorporating the catalyst-coated membrane to be tested. The cell temperature was held at to 80° C. and the anode and cathode pressure were set to 2 bar. Next, the current density was set to 2 A/cm². The cathode pressure was increased stepwise from 2 to 6, to 10 bar with a minimal duration of 45 minutes for each step. The % of H₂ in the oxygen at the anode gas outlet was measured by a Compact GC 4.0 Gas Chromatograph (GC) from Global Analysis Solutions. The CCM with PVP-Pt particles in the membrane did not reach equilibrium at the 2-bar test before the pressure was changed therefore no data is presented for this value, however it did remain under 0.4% hydrogen crossover.

FIG. 5 shows the results of the hydrogen crossover testing of the CCMs. These results show that the membrane formed from the PVP-Pt particles provides the greatest reduction in hydrogen crossover.

### Example 6—Formation of a Stabilised Dispersion of Platinum Nanoparticles Using PVP and Formaldehyde

Pt(NO₃)₄ (equivalent to 1 g of Pt) was added to water (500 mL) and stirred. PVP10 (average molecular 10,000, 8.5g) was added followed by the addition of formaldehyde (37% in water, 20.8 g). The mixture was heated to 68° C. and then allowed to cool to room temperature and stirred overnight to form a dispersion.

### Example 7—Formation of an Ion-Conducting Polymer Inks Containing PVP-Stabilised Nanoparticles

A stabilised aqueous dispersion of Pt nanoparticles (formed according to a method analogous to Example 6) was mixed with ethanol and water to create a mixture with a ethanol: water weight ratio of 80:20. Dry ionomer (3M Corp, 800 EW) is added to the mixture to create a dispersion, where the ionomer solids is ˜17% wt.

### Example 8—Hydrogen Cross-Over Testing at a Range of Pt Loadings

A series of catalyst-coated membranes were prepared with different loadings of stabilised Pt nanoparticles and the following structure:
(1) Pt/C-containing cathode layer
(2) ˜60 micron PFSA membrane (with two ePTFE reinforcements)
(3) ˜10 micron Pt-containing recombination catalyst layer
(4) ˜10 micron PFSA membrane layer
(5) Iridium oxide (IrOx)-containing anode layer

Layers 2, 3, and 4 were applied using film applicators (slot die and baker coater). Layers 1 and 5 were attached to the composite layer 2-3-4 using lamination at a temperature greater than the ionomers transition temperature (160° C.).

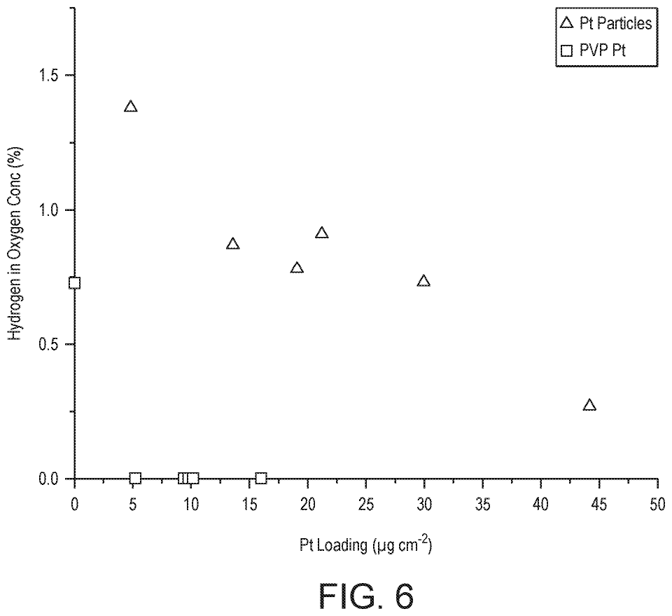

The recombination catalyst layers were prepared with either (i) ion-conducting polymer inks containing PVP-stabilised Pt nanoparticles (“PVP-Pt” in FIG. 6) prepared using a method analogous to that of Example 7; or (ii) ion-conducting polymer inks containing unsupported Pt particles (without the use of PVP) (“Pt particles” in FIG. 6).

The CCMs were tested for hydrogen cross-over as shown in FIG. 6. This shows that the use of a stabilised nanoparticle dispersion (Pt-PVP) can achieve almost complete reaction of hydrogen crossing through the membrane under the test conditions even at low platinum loading, with significantly improved performance when considered alongside comparative CCMs not prepared with a stabilised nanoparticle dispersion.

1. A process for producing an ion-conducting membrane comprising a recombination catalyst-containing membrane layer, the process comprising the steps of:
(i) providing a stabilised dispersion of recombination catalyst nanoparticles;
(ii) mixing the stabilised dispersion with an ion-conducting polymer to form an ink;
(iii) fabricating the membrane layer from the ink.

2. A process according to claim 1, wherein the recombination catalyst nanoparticles comprise platinum and/or palladium.

3. A process according to claim 1, wherein the stabilised dispersion of recombination catalyst nanoparticles comprises a nanoparticle stabilising agent with a higher hydrophobicity and/or a lower water uptake value than the ion-conducting polymer used in step (ii).

4. A process according to claim 1, wherein the stabilised dispersion comprises a polymeric nanoparticle stabilising agent.

5. A process according to claim 1, wherein the nanoparticle stabilising agent is polyvinylpyrrolidone (PVP).

6. A process according to claim 1, wherein step (iii) comprises depositing the ink onto a substate, such as a backing sheet, an ion-conducting polymer layer, or a catalyst layer on a backing sheet.

7. A process according to claim 6, wherein the substrate is a first ion-conducting polymer layer, and the process comprises step (iv) adding a second ion-conducting polymer layer such that the recombination catalyst-containing membrane layer is disposed between the first and the second ion-conducting polymer layers.

8. A process according to claim 1, further comprising the step of forming a catalyst layer on at least one face of the membrane to form a catalyst coated membrane.

9. A process according to claim 8, further comprising the step of applying a seal material to at least one face of the catalyst-coated membrane.

10. (canceled)

11. (canceled)

12. (canceled)

13. An ion-conducting membrane for an electrochemical device, such as a fuel cell or a water electrolyser, comprising a recombination catalyst-containing membrane layer, the membrane layer comprising dispersed recombination catalyst nanoparticles, a nanoparticle stabilising agent, and an ion-conducting polymer.

14. An ion-conducting membrane according to claim 13, wherein the nanoparticle stabilising agent has a higher hydrophobicity and/or a lower water uptake value than the ion-conducting polymer.

15. An ion-conducting membrane according to claim 13, wherein the recombination catalyst nanoparticles are in the form of clusters of discrete nanoparticles.

16. An ion-conducting membrane according to claim 13, wherein the nanoparticle stabilising agent is a polymer, such as polyvinylpyrrolidone.

17. An ion-conducting membrane according to claim 13, wherein the recombination catalyst nanoparticles are at least partially coated with the nanoparticle stabilising agent.

18. An ion-conducting membrane according to claim 13, wherein the average particle size of the nanoparticles is less than 50 nm.

19. An ion-conducting membrane according to claim 13, wherein the membrane has a thickness in the range of and including 30 to 90 mm.

20. An ion-conducting membrane according to claim 13, wherein the recombination catalyst-containing membrane layer has a thickness in the range of and including 5 to 30 mm.

21. An ion-conducting membrane according to claim 13, wherein the membrane is a single coherent polymer film comprising a plurality of ion-conducting polymer layers.

22. An ion-conducting membrane according to claim 13, comprising a first ion-conducting polymer layer and a second ion-conducting polymer layer, and wherein the recombination catalyst-containing membrane layer is disposed between the first and the second ion-conducting polymer layers.

23. An ion-conducting membrane according to claim 22, wherein the first ion-conducting polymer layer has a thickness in the range of and including 5 mm to 30 mm, preferably in the range of and including 5 mm to 20 mm.

24. An ion-conducting membrane according to claim 22, wherein the second ion-conducting polymer layer has a thickness in the range 10 mm to 90 mm, preferably in the range of and including 40 mm to 70 mm.

25. A catalyst-coated membrane for an electrochemical device, such as a fuel cell or a water electrolyser, comprising an ion-conducting membrane according to claim 13.

26. (canceled)

27. (canceled)
